(19) United States
(12) Patent Application Publication
(10) Pub. No.: US 2003/0131074 A1
(43) Pub. Date: Jul. 10, 2003

(54) Device and method that enables voice mailbox in internet communication products

(76) Inventors: Cheng-Shing Lai, Taipei (TW); Qiang-Hua Song, Nanjing (CN); Xu-Wei Tu, Nanjing (CN)

Correspondence Address: BIRCH STEWART KOLASCH & BIRCH, PO BOX 747, FALLS CHURCH, VA, 22040-0747, US

(21) Appl. No.: 10/036,435

(22) Filed: Jan. 7, 2002

(51) Int. Cl. G06F 15/16

(52) U.S. Cl. 709/219; 709/206

(57) ABSTRACT

A device and method that enables Internet communication products equipped with Web linkage functions to have the functions of a voice mailbox available only in general telecommunication systems or voice telephones through the multimedia service of the Internet. The invention uses the sound recording, playing functions and Internet communication of Internet communication products to turn voice data recorded and receiver's data into a voice message packet which is then sent to a Web server for storage, so that voice message can be retrieved from the voice mailbox when receiver's Internet communication products are linked to the Web server by Internet, to receive and send voice mail as well as use the voice mailbox.

### BACKGROUND OF THE INVENTION

1. Field of the Invention

The invention relates to a device and method that enables Internet communication products to receive and send electronic voice mail, and more particularly, to a device and method that enables the sending and receiving of voice mail through the Internet, by means of a PDA, PC, notebook computer, or hand-held PC, for example.

2. Related Art

Because of the rapid development of mobile phone industry and the promotion by the mobile communication service industry, cellular phone has been so popular that it is almost owned by everybody; utility model of cellular phone not only transmits each speaker's voice, but also possesses multimedia functions necessary for the new generation of cellular phone. Telecommunication suppliers not only provide the most basic 2-way voice transmission service, but also provide functions such as message, Web surfing, and even voice mailbox that frees both the receiver and the sender who fail to communicate with each other by voice instantly from the complicated process of keying in the text of a message to be sent.

The voice mailbox usually carries out the recording, playing and storage of sounds by means of a telecommunication network and an ordinary voice telephone. For instance, under a mobile communication service system (e.g. GSM system), a sender can leave a voice message in a voice mailbox provided by a telecommunication supplier. However, the user has to pay an additional charge for using the voice mailbox. With an ordinary voice telephone system, a voice message can be left on a digital answering machine.

Given the rapid development of Internet, Internet communication products such as PDA, PC, notebook or hand-held PC, which possess the function of Web linkage, but not the functions of cellular phone, have been popularized to a great extent. Although many Internet communication products nowadays can use built-in modem chip to receive and send email or browse Web page, most of them can only receive and send simple text files. As regards to PC, it possesses the most complete functions, enabling a user to receive and send, at the user's own choice, all kinds of multimedia messages or files, such as a voice document, to allow a friend at the receiver end to listen to a sender's greetings. Although all the other Internet communication products are equipped with modems (or modem chips) that have sound recording and playing functions, so far there has not been any known technology through which the functions of voice mailbox are enabled.

### SUMMARY OF THE INVENTION

The primary object of the invention is to provide a device and method that enables Internet communication products to have the function of a voice mailbox.

The method revealed by the present invention is aimed at, and designed for, those Internet communication products that merely possess Web linkage function, but do not have the functions of ordinary voice telephone. For instance, all PDA or hand-held PC that possesses Web linkage function may enable the function of voice mailbox through the technology of the present invention.

The technology employed by the invention involves a voice message being picked up by a microphone of an Internet communication product. The voice message is then recorded by means of the sound recording function of the Internet communication product, resulting in the creation of a voice file. After that, a recipient's information and voice file are turned into a voice message packet that is then sent to a Web server via the Internet for storage. After connecting with the Web server via the Internet, the recipient may download from the Web server a corresponding voice message packet, which will be available to the recipient's Internet communication product. Eventually, the voice message is played by means of the voice playing function of the Internet communication product, so that the functions of a voice mailbox will be attained.

The description of the detailed technology and embodiment of the present invention is made with reference to the accompanying drawings.

### BRIEF DESCRIPTION OF THE DRAWINGS

The invention will become more fully understood from the detailed description given herein below. However, this description is for purposes of illustration only, and thus is not limitative of the invention, wherein:

FIG. 1 is a diagram showing the systemic structure for the implementation of the invention.

FIG. 2 shows the basic structure of Internet communication products.

FIG. 3 is a diagram showing the structure of another embodiment of Internet communication products.

FIG. 4 is the flowchart about the main steps of the method for the present invention.

FIG. 5 is the flowchart about the embodiment for creating a voice message packet.

FIG. 6 is the flowchart about the embodiment for sending a voice message packet.

FIG. 7 is the flowchart about the embodiment for receiver's downloading a voice message packet.

FIG. 8 is the flowchart about the embodiment for playing a voice message packet.

| 10a, 10b | Internet communication products |
|---|---|
| 11 | Internet connection port |
| 12 | microphone |
| 13 | speaker |
| 14 | modem chip |
| 15 | microprocessor unit |
| 151 | Internet communication program |
| 152 | sound recording program |
| 153 | sound playing program |
| 16 | input unit |
| 17 | display unit |
| 18 | register |
| 20 | Web server |

### DETAILED DESCRIPTION OF THE INVENTION

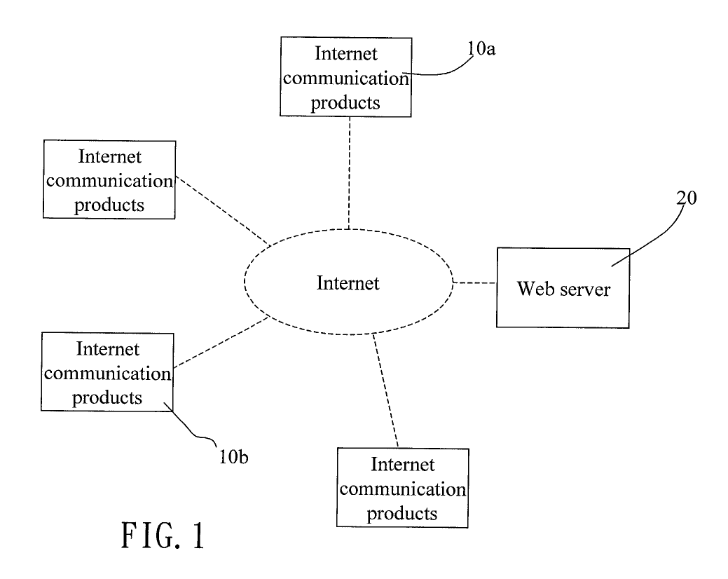

First of all, see FIG. 1, which is a diagram showing the systemic structure of the present invention, comprising the following components that are linked together via Internet:

A local Internet communication product 10a that has the functions of sound recording and playing, and Internet linkage. This is the sender, and it produces a voice message packet;

A Web server 20, which is linked to Internet communication product 10a by Internet, in order to allow the Internet communication product 10a to upload and download voice message packets; and

A remote Internet communication product 10b that also has the functions of sound recording and playing, and Internet linkage. This is the recipient. After being linked to the Web server 20 over the Internet, it downloads the voice message packets stored in the Web server 20, and it eventually plays the voice messages contained in the voice message packets.

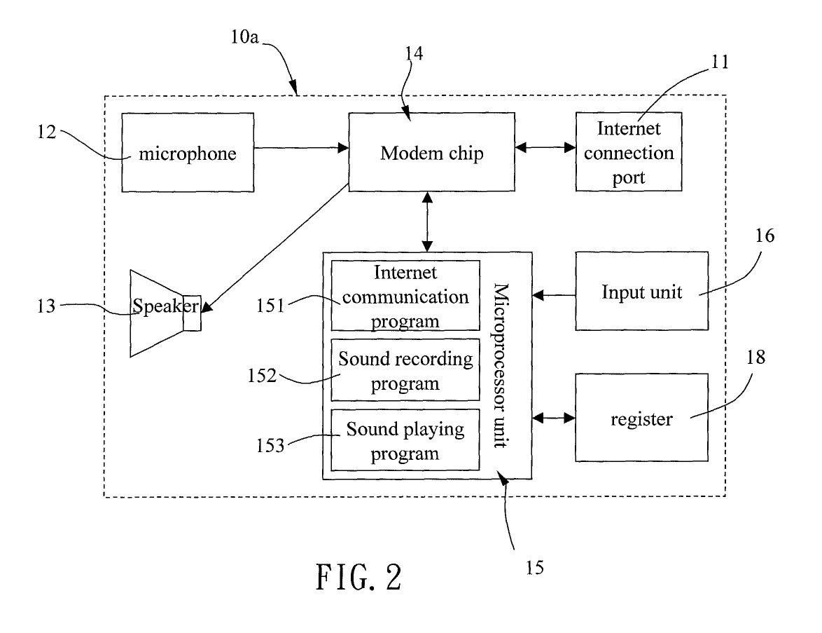

The foregoing Internet communication product 10a, 10b can either be a PDA, or a hand-held PC, equipped with the function of Web linkage. The basic structure of such an Internet communication product, as depicted in FIG. 2, comprises:

An Internet connection port 11, such as an RJ11 connector, for connecting to the Internet and thus creating an Internet communication path;

A microphone 12 for picking up a user's message and converting it into an electrical signal;

A speaker 13 for playing a voice message downloaded from the Internet;

A modem chip 14 for linking to the Internet so as to facilitate the transmission and receipt of data;

A register 18 for storing the data of a voice message by means of either RAM or flash memory;

A microprocessor unit 15, which comprises a built-in Internet communication program 151, a built-in sound recording program 152 and a built-in sound-playing program 153. The built-in Internet communication program 151, when executed, enables the modem chip 14 to upload or download data via Internet. The built-in sound recording program 152 enables the modem chip 14 to start converting a voice message picked up by the microphone 12 into a voice file, and then storing the voice file in the register 18. The built-in sound playing program 153 enables the modem chip 14 to start disassembling the voice message packets downloaded from the Web server 20, and then playing the voice message through the speaker 13; and

An input unit 16, for example, a touch screen, keyboard, or both, that allows users to control the Internet communication product 10a or 10b in sending or receiving voice messages.

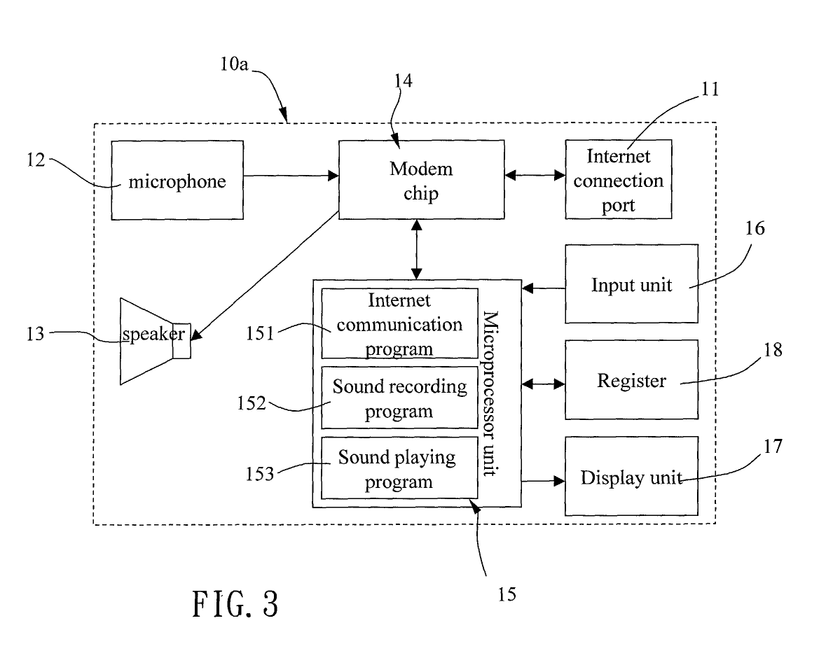

Of course, the aforesaid Internet communication product 10a, 10b can also comprise a display unit 17 (see FIG. 3), for example a touch screen, a LCD or an indicator light. Such a display unit 17 is controlled by the microprocessor unit 15, and its purpose is to display a prompt message so as to instruct a user to carry out the operation of the sound recording or the receipt of a voice message.

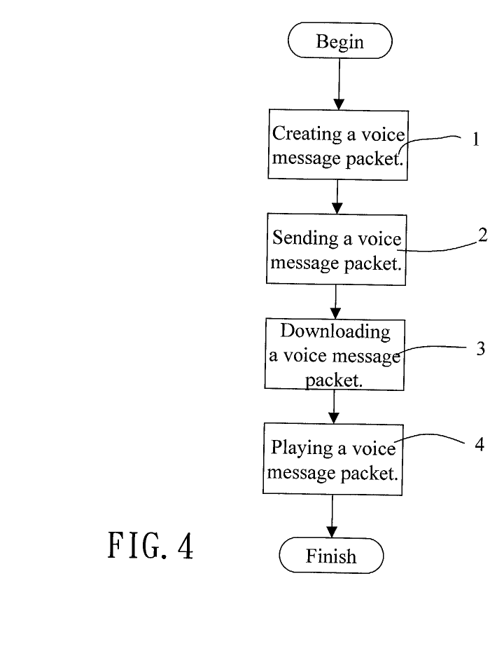

Please continue to FIG. 4, which is a flow chart of the main steps of the method of the invention. It comprises:

1. The step of creating a voice message packet. It uses the sound recording function of the Internet communication products 10a to turn sender's voice message and receiver's information (such as receiver's identification data or email address) into a voice message packet;

2. The step of sending a voice message packet. It uses the Internet communication function of the Internet communication product 10a to send a voice message packet to a Web server 20;

3. The step of downloading a voice message packet. Receiver uses the Internet communication function of the Internet communication product 10b to link up itself with a Web server 20 through Internet, and from the Web server 20 it downloads corresponding voice message packets to receiver's Internet communication product 10b; and

4. The step of playing a voice message packet. It uses the sound playing function of the recipient's Internet communication product 10b to disassemble and play the downloaded voice message packet.

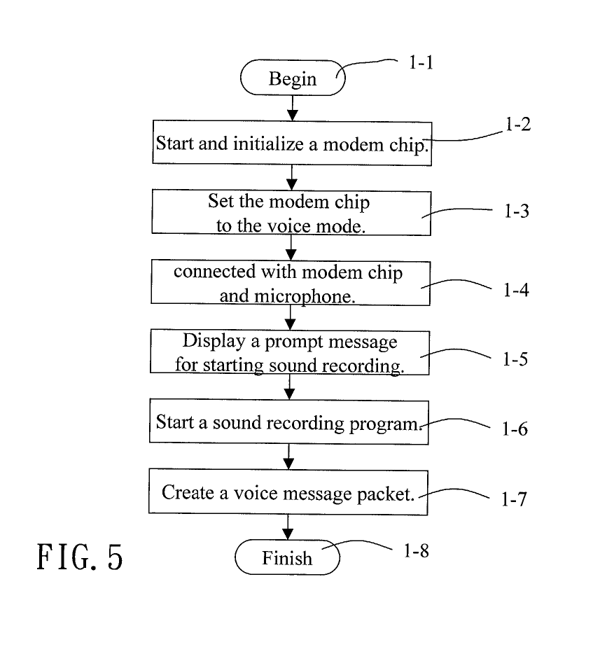

As shown in FIG. 5, the detailed procedures of the foregoing creation of a voice message packet are as follows:

| | |
|---|---|
| 1-1 | Begin. It starts after a user has given a sound recording command |
| | through an input unit 16; |
| 1-2 | Start and initialize a modem chip 14. In other words, it starts the |
| | modem chip 14, and sends an initialization command to keep the |
| | modem chip 14 in a preparation status; |
| 1-3 | Set the modem chip 14 to the voice mode, for example, a micro- |
| | processor unit 15 sends a modem chip 14 a command, “AT#CLS = |
| | 8”; |
| 1-4 | Start the connection mode of microphone 12 and modem chip 14, for |
| | example, a microprocessor unit 15 sends a modem chip 14 a |
| | command, “AT# VLS = 3”; |
| 1-5 | Cause a display unit 17 to display a prompt message for starting |
| | sound recording (for example, a text message or a glittering light); |
| 1-6 | Start a sound recording program, and cause the modem chip 14 to |
| | convert the voice message picked up by the microphone 12 into a |
| | voice file that will then be stored in a register 18. For example, a |
| | microprocessor unit 15 sends a modem chip 14 a command, “AT# |
| | VRX”; |
| 1-7 | Create a voice message packet. Turn the sender's information (such |
| | as the recipient's identification data or email address) and voice file |
| | into a voice message packet and store the voice message packet in the |
| | register 18; and |
| 1-8 | End the generation of the voice message packet. |

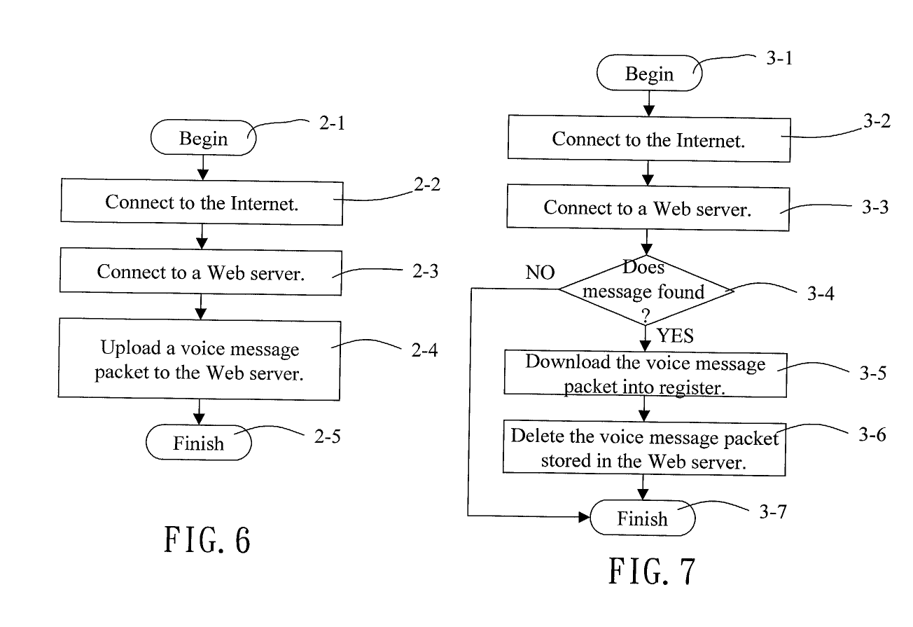

As shown in FIG. 6, detailed embodiment procedures of sending a voice message packet are as follows:

| | |
|---|---|
| 2-1 | Begin. It starts after a user has given a command through an input |
| | unit 16; |
| 2-2 | Connect with Internet; start a modem chip 14 so as to connect with |
| | Internet; |
| 2-3 | Connect with a Web server 20; |
| 2-4 | Upload a voice message packet to the Web server 20; and |
| 2-5 | End Internet connection. |

As shown in FIG. 7, the detailed procedures of the recipient downloading a voice message packet are as follows:

| | |
|---|---|
| 3-1 | Begin. It starts after a user has given a command through an input |
| | unit 16; |
| 3-2 | Connect to the Internet; start a modem chip 14 so as to connect to the |
| | Internet; |
| 3-3 | Connect to a Web server 20; |
| 3-4 | Look for a voice message packet stored in the Web server 20; |
| | according to the default recipient's information-the search condition, |
| | go to the next step whenever a corresponding voice message packet is |
| | found, otherwise end the Internet connection; |
| 3-5 | Download the voice message packet stored in the Web server 20 and |
| | store it in a register 18; |
| 3-6 | Delete the voice message packet stored in the Web server 20; and |
| 3-7 | End the Internet connection. |

Of course, in the aforesaid steps 3-5, the identity of the recipients who download voice message packets can be scanned by means of identification and inspection, or through a safety procedure of encryption/decryption, so that only those recipients who pass the identification and inspection of identity can be allowed to download voice message packets.

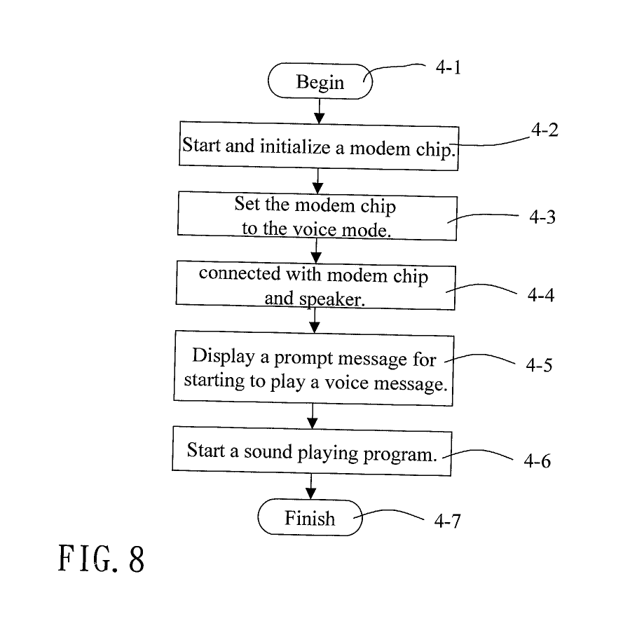

Finally, as shown in FIG. 8, detailed procedures about playing a voice message packet are as follows:

| | |
|---|---|
| 4-1 | Begin. It starts after a user has given a playing command through an |
| | input unit 16; |
| 4-2 | Start and initialize a modem chip 14. In other words, it starts the |
| | modem chip 14, and sends an initialization command to keep the |
| | modem chip 14 in a preparation status; |
| 4-3 | Set the modem chip 14 to the voice mode, for example, a micro- |
| | processor unit 15 sends a modem chip 14 a command, “AT#CLS = |
| | 8”; |
| 4-4 | Start the connection mode of speaker 13 and modem chip 14, for |
| | example, a microprocessor unit 15 sends a modem chip 14 a |
| | command, “AT# VLS = 2”; |
| 4-5 | Cause a display unit 17 to display a prompt message about starting to |
| | play a voice message (for example, a text message or a glittering |
| | light); |
| 4-6 | Start a sound playing program, and cause the modem chip 14 to |
| | disassemble a voice message packet, that is, cause the modem chip 14 |
| | to disassemble the voice message packet downloaded from a Web |
| | server 20, and then play the voice message through speaker 13. For |
| | example, a microprocessor unit 15 sends a modem chip 14 a |
| | command, “AT# VTX”; and |
| 4-7 | End playing voice message. |

### EFFECT OF THE INVENTION

Making good use of the functions of sound recording, sound playing and Internet communication of Internet communication products, coupled with the Web servers of Internet, provide paths for receiving and sending voice messages as well as places for storing voice messages, so that Internet communication products that possess the function of Web linkage, but not the function of ordinary voice telephone, can gain access to the service of voice mailbox.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. A device that enables voice mailbox in Internet communication products, allowing Internet communication products that possess the function of Web linkage to enable the function of voice mailbox through the Web servers of Internet. It comprises:
An Internet connection port for connecting with Internet and thus creating Internet communication paths;
A microphone for picking up a user's message and converting it into an electrical signal;
A speaker for playing a voice message downloaded from Internet;
A modem chip for linking to Internet so as to facilitate the transmission and receipt of data;
A register for storing the data of a voice message;
A microprocessor unit that comprises a built-in Internet communication program, a built-in sound recording program and a built-in sound playing program. The built-in Internet communication program, when executed, enables the modem chip to upload or download data via Internet. The built-in sound recording program enables the modem chip to start converting a voice message picked up by the microphone into a voice file, then turn the voice file and receiver's information into a voice message packet, and finally store the voice message packet in the register. The built-in sound playing program enables the modem chip to start disassembling the voice message packets downloaded from the Web server, and then playing the voice message through the speaker; and
An input unit that allows users to control the microprocessor unit in sending or receiving voice messages.

2. A device that enables voice mailbox in Internet communication products of claim 1, wherein the Internet connection port is selected from the group consisting of a RJ11 connector and a RJ45 connector.

3. A device that enables voice mailbox in Internet communication products of claim 1, wherein the input unit is selected from the group consisting of a touch screen and a keyboard.

4. A device that enables voice mailbox in Internet communication products of claim 1, wherein it also comprises a display unit controlled by the microprocessor unit, for displaying a prompt message.

5. A device that enables voice mailbox in Internet communication products of claim 4, wherein the display unit is selected from the group consisting of a touch screen, a liquid crystal display and a pilot lamp.

6. A method that enables voice mailbox in Internet communication products, allowing Internet communication products that possess the function of Web linkage to enable the function of voice mailbox through the Web servers of Internet in accordance with the steps mentioned below. It comprises:
A. The step of creation of a voice message packet. It turns sender's voice message and recipient's information into a voice message packet by means of the sound recording function of an Internet communication product;
B. The step of sending a voice message packet. It sends a voice message packet to a Web server by means of the Internet communication function of an Internet communication product;
C. The step of downloading a voice message packet. Recipient uses the Internet communication function of an Internet communication product to link up itself with a Web server through Internet, and from the Web server it downloads a corresponding voice message packet to recipient's Internet communication product; and
D. The step of playing a voice message packet. It uses the sound playing function of recipient's Internet communication product to disassemble and play the voice message packet downloaded.

7. The method that enables voice mailbox in Internet communication products as claimed in claim 6, wherein the recipient's information is selected from the group consisting of the recipient's identification data and the recipient's email address.

8. The method that enables voice mailbox in Internet communication products as claimed in claim 6, wherein the step of creation of a voice message packet also comprises the step of using an built-in modem chip of an Internet communication product to convert a voice message picked up by a microphone into a voice file and then turn the voice file and recipient's information into a voice message packet.

9. The method that enables voice mailbox in Internet communication products as claimed in claim 8, wherein the step of creation of a voice message packet also comprises:
I. Start and initialize the modem chip in order to keep the modem chip in a preparation status;
II. Set the modem chip to the voice mode;
III. Start the connection mode of the microphone and the modem chip;
IV. Display a prompt message about starting sound recording;
V. Start a sound recording program, and cause the modem chip to convert the voice message picked up by the microphone into a voice file; and
VI. Turn the recipient's information and the voice file into a voice message packet, and store the voice message packet in the register.

10. The method that enables voice mailbox in Internet communication products as claimed in claim 9, wherein the prompt message is selected from the group consisting of a text message and a glittering light.

11. The method that enables voice mailbox in Internet communication products as claimed in claim 6, wherein the step of sending a voice message packet also comprises uploading a voice message packet to a Web server by means of an built-in model chip of an Internet communication product.

12. The method that enables voice mailbox in Internet communication products as claimed in claim 6, wherein the step of downloading a voice message packet comprises:
I. Start connecting a modem chip to Internet;
II. Connect to a Web server;
III. Look for a voice message packet stored in the Web server; go to next step whenever a corresponding voice message packet is found, otherwise end Internet connection;
IV. Download the voice message packet stored in the Web server;
V. Delete the voice message packet stored in the Web server; and
VI. End Internet connection.

13. The method that enables voice mailbox in Internet communication products as claimed in claim 12, wherein a corresponding voice message packet is looked for according to default recipient's information.

14. The method that enables voice mailbox in Internet communication products as claimed in claim 6, wherein the step of playing a voice message packet also comprises using an built-in modem chip of an Internet communication product to disassemble a downloaded voice message packet and then playing the voice message through a speaker.

15. The method that enables voice mailbox in Internet communication products as claimed in claim 14, wherein the step of playing a voice message packet comprises:
I. Start and initialize the modem chip in order to keep the modem chip in a preparation status;
II. Set the modem chip to the voice mode;
III. Start the connection mode of the speaker and the modem chip;
IV. Display a prompt message about starting to play a voice message; and
V. Start a sound playing program, and cause the modem chip to disassemble a voice message packet, and then play the voice message through speaker.

16. The method that enables voice mailbox in Internet communication products as claimed in claim 15, wherein the prompt message is selected from the group consisting of a text message and a glittering light.
